(19) United States
(12) Patent Application Publication
(10) Pub. No.: US 2004/0022132 A1
(43) Pub. Date: Feb. 5, 2004

(54) Variable mode display for time measurement devices

(76) Inventor: Richard Rund, Great Falls, VA (US)

Correspondence Address: CAHN & SAMUELS LLP, 2000 P STREET NW, SUITE 200, WASHINGTON, DC, 20036, US

(21) Appl. No.: 10/394,169

(22) Filed: Mar. 24, 2003

Related U.S. Application Data
(60) Provisional application No. 60/399,456, filed on Jul. 31, 2002.

(51) Int. Cl. G04C 19/00

(52) U.S. Cl. 368/82

(57) ABSTRACT

A timer for a time measurement device includes a display field that displays measured time in a first set of time units, e.g., hours/minutes. The display also includes a user activated input device for toggling the displayed time to a second set of time units, e.g., minutes/seconds.

This application claims priority from provisional application Serial No. 60/399,456 filed Jul. 31, 2002.

### I. FIELD OF THE INVENTION

This invention relates to time measurement devices and more particularly to timers and chronographs having displays with switchable time units.

### II. BACKGROUND OF THE INVENTION

Various conventional devices permit measurement of different time intervals. For example, stopwatches are capable of measuring a period of time to hundredths or thousandths of a second, with the press of a single button. Such devices have various advantageous features, such as the ability to time multiple runners within the same race. Other examples include “kitchen timers”, which may be used to measure an amount of cooking time. Such devices may be capable of counting “up” (i.e. measuring an indefinite period of time starting from a time zero) or “down” (i.e., counting down from a preset time until zero).

Since the many events being measured by timing devices may vary in length, a corresponding kitchen timer measuring only hours and minutes may be of limited use in measuring runners in a 100 meter race, whereas the high accuracy of a stopwatch may be wasted measuring the cooking of a turkey. Moreover, since a given timer is often used for measuring different events, it would be advantageous for a timer to have the ability to switch between different levels of accuracy at the direction of the user.

Conventional timers of which the instant inventors are aware do not have such an ability. For example, the game timer described in published U.S. patent application Ser. No. US/2001/0034256 A1 time may be initially displayed in hours and decrease in one hour increments until less than one hour remains. At that point, the time display automatically switches to minutes and decreases in one minute increments. When less than one minute remains, the time display automatically switches to seconds and decreases in one second increments.

### III. SUMMARY OF THE INVENTION

It is an object of the invention to provide a display for a timing device that permits a user to choose a mode of operation that is best suited to the user's need.

It is another object of the invention to provide a timing device that allows a user to conveniently switch between various display modes, each mode having a different degree of timing resolution.

It is still a further object of the invention to provide a timer with broad consumer appeal.

These and other objects may be accomplished, according to the invention, by a display for a time measurement device that permits substantial user flexibility in selecting time units in which measured time is displayed. The user may switch between a “hours/minutes” display mode and a “minutes/seconds” display mode; between “minutes/seconds” and “seconds/tenths of seconds”; between “hours/minutes/seconds” and “minutes/seconds/tenths of seconds”; between “minutes/seconds/tenths of seconds” and “seconds/tenths of seconds/hundredths of seconds”; etc. The display preferably includes a time display field having anywhere from 2 to 8 or more time units for displaying a time measurement, depending on the particular implementation and the needs of the user.

### IV. BRIEF DESCRIPTION OF THE DRAWINGS

FIG. 1 depicts a display according to the invention illustrating the display time field in time units of hours and minutes.

FIG. 2 shows a display according to the invention depicting the display time field in time units of minutes and seconds

FIG. 3 illustrates a schematic diagram of an exemplary chip for implementing the functionality of the present invention.

### V. DETAILED DESCRIPTION OF THE DRAWINGS

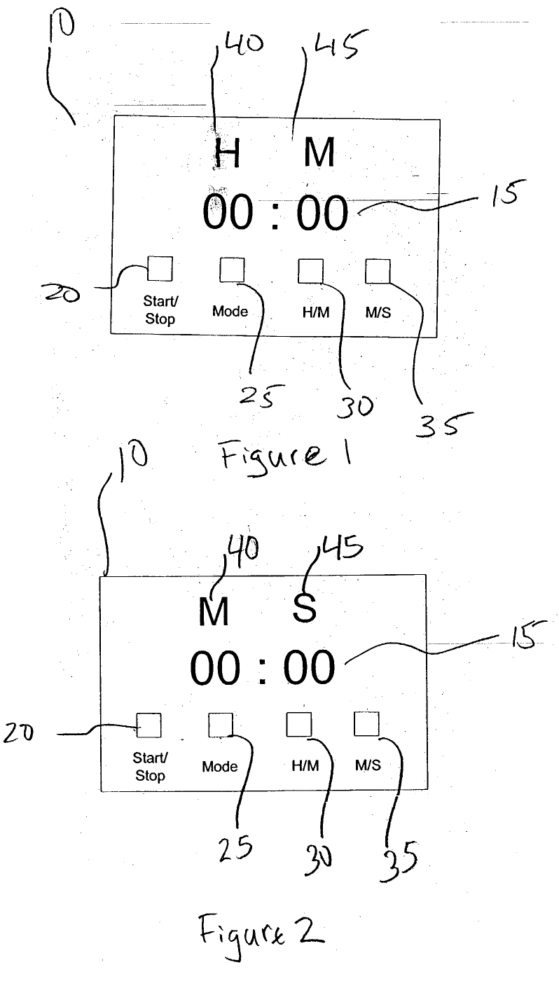

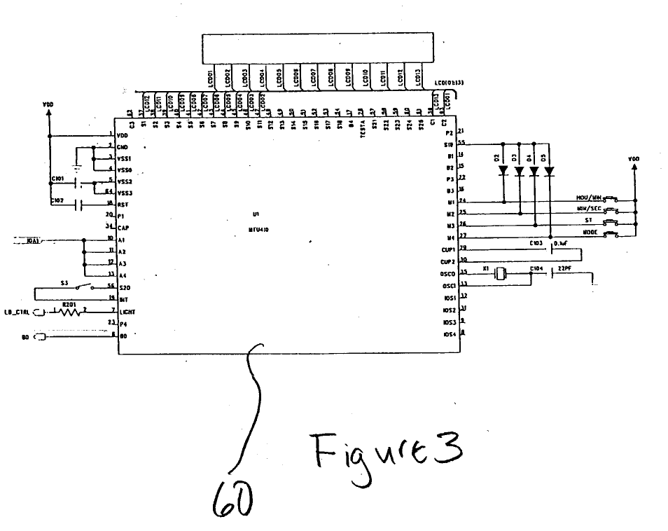

FIGS. 1 and 2 illustrate an exemplary embodiment of a display 10 according to the invention. Display 10 includes a time display field 15 and may include a start/stop button 20, a mode button 25, and H/M (hour/minute) button 30 and a M/S (minute/second) button 35. In accordance with the invention, a user may switch display field 15 between a first set of time units 40 and a second set of time units 45. In an exemplary embodiment, the first set of time units 40 comprises “hours/minutes” (shown in FIG. 1) and the second set of time units 45 includes “minutes/seconds” (shown in FIG. 2). In some embodiments, such a conversion may be made by simply pressing mode button 25 which toggles the display between the first set of time units 40 and the second set of time units 45. In other embodiments, the conversion could be implemented by sliding a switch that alternates between the first set of time units 40 and the second set of time units 45. In still other embodiments, the conversion may be implanted by depressing h/m button 30 which causes the measured time to be displayed in hours/minutes and pressing m/s button 35 which converts the measured time to minutes/seconds.

In keeping with the invention, display field 15 may comprise a greater number of time units than hours, minutes and seconds. More particularly, display field 15 may comprise up to 8 or more individual time units such as tenths of seconds, hundredths of seconds, thousandths of seconds, etc. In addition, first and second sets of time units 40 and 45, respectively, may comprise any combination of individual time units. For example, the first set of time units 40 may include hours and minutes and the second set of time units 45 may include minutes, seconds and tenths of seconds. Thus, for example, the user may toggle display field 15 between an hours/minutes mode and a minutes/seconds/tenths of seconds mode.

In keeping with another feature of the invention, display field 15 may include a plurality of modes. For example, the user may be able to switch between hours/minutes mode, minutes/seconds mode and seconds/tenths of seconds mode using mode button 25 or a button dedicated to the desired mode, i.e., hours/minutes button 30, minutes/seconds button 35, seconds/tenths of seconds button (not shown). In this way the user may choose which mode is best suited for a particular measurement, while simultaneously minimizing a size of the display 10.

In accordance with an aspect of the invention, a user may select a mode of operation and proceed throughout the remainder of the measurement in that mode. That is, a user selecting “hours/minutes” mode would not be able to observe the number of seconds passing without restarting the measurement in “minutes/seconds” mode. In accordance with another aspect of the invention, the user may switch between modes throughout the measurement. In this way, a user counting down, for example, from two hours to zero might initially select the “hours/minutes” mode. However, as the time counts down, at some point, the user might wish to switch modes so as to be able to view the number of seconds remaining as well. The user could then switch back to the “hours/minutes” mode, if desired.

As mentioned above, although FIGS. 1 and 2 illustrate an exemplary set of buttons 25, 30 and 35, based on the teachings contained herein, it should be understood that many different display configurations could be implemented. For example, H/M button 30 and M/S button 35 may be incorporated into mode button 25 which may be additionally or separately used for other functionality, such as an alarm. In FIGS. 1 and 2, “H”, “M” and “S” icons are preferably displayed above numerals of display field 15 to indicate time units of hours, minutes and seconds, respectively. As previously mentioned, other representative icons may be employed to indicate other time units such as tenths of seconds, hundredths of seconds, etc. Also, certain display modes may not utilize the entire display field. For example, display field 15 may include time units of hours, minutes and seconds. However, the user may select the “minutes/seconds” display mode. In this case the hours time unit would simply be inactive.

In keeping with the invention, display 10 is preferably operated through use of a micro controller unit. FIG. 3 shows a preferred microcontroller unit (MCU) 60, a Multifunction Timer Pulse Unit, MTU410, available from Myson Century Semiconductor, Inc. of San Jose, Calif. MCU 60 may be a single-chip 4-bit micro-controller with LCD drivers and a built-in clock generator. MCU 60 may be AC powered or DC powered. More particularly the MCU 60 may include a 1.5 V power supply and has both countdown and count up functions. MCU 60 preferably includes an H/M mode with 19 hour 59 minute countdown and count up functions and a M/S mode with a 99 minute 59 second countdown and count up functions. When power is up, the position of switch s3 may be checked to determine the default mode. The user may toggle the mode between H/M and M/S as desired. Because pin P19 is an inner pull down pin which consumes power when it is connected to VCC, pin P56 is preferably employed to output a square wave having a frequency of about 5.8 Hz and a pulse width of about 480 μS. In this configuration, pull down pin P19 will only consume power during the 480 μs pulse amounting to about 2% of what would be consumed if pin P19 were connected to vcc.

Display 10 of the present invention may be incorporated into various devices where time measurement is useful. For example, display 10 may be incorporated in a timer which may be utilized either as a kitchen timer where more coarse time measurement is employed or as an athletic timer where more fine time measurement is desired since the time units may be toggled with the flip of a switch. In addition, the display of the present invention may be incorporated in kitchen appliances such as a stoves, blenders, toasters, rice cookers, crock pots etc. The display of the present invention may also be incorporated in exercise machines such as treadmills, rowing machines, stationary bikes and the like.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

We claim:

1. A display for a time measurement device comprising:
a time display field that displays measured time in a first mode defined by a first set of time units; and
user controllable means for switching the displayed time to a second mode defined by a second set of time units.

2. The display of claim 1 wherein the first set of time units includes a plurality of time units.

3. The display of claim 2 wherein the second set of time units includes a plurality of time units.

4. The display of claim 1 wherein the first set of time units includes hours and minutes and the second set of time units includes minutes and seconds.

5. The display of claim 1 wherein the first set of time units includes minutes and seconds and the second set of time units includes seconds and tenths of seconds.

6. The display of claim 1 wherein said user controllable means switches the displayed time from a first set of time units to a second set of time units without interrupting time measurement responsive to a user command.

7. The display of claim 1 wherein said user controllable means restarts time measurement when the displayed time is switched from the first set of time units to the second set of time units.

8. A display for a time measurement device comprising:
a time display field that displays measured time in a first mode defined by a first set of time units; and
an input device that, upon activation, switches the display field to a second mode defined by a second set of time units.

9. The display of claim 8 wherein the input device comprises a single mode button that toggles the display between modes upon activation.

10. The display of claim 8 wherein the input device comprises a plurality of dedicated mode buttons that drive the display to a desired mode upon activation.

11. The display of claim 8 wherein the input device comprises a switch.

12. A method for displaying measured time comprising:
displaying measured time in a first set of time units; and
switching the displayed time from a first set of time units to a second set of time units responsive to a user input.

13. The method of claim 11 further comprising restarting a time measurement responsive to said switching step.
